(19) United States
(12) Patent Application Publication
(10) Pub. No.: US 2014/0127098 A1
(43) Pub. Date: May 8, 2014

(54) Ammonia Slip Reduction

(71) Applicant: International Engine Intellectual Property Company, LLC, Lisle, IL (US)

(72) Inventors: Adam C. Lack, New York, NY (US); Navtej Singh, Arlington Heights, IL (US); Paul Boon Charintranond, Elmhurst, IL (US); Michael James Miller, Mt. Prospect, IL (US)

(21) Appl. No.: 14/070,662

(22) Filed: Nov. 4, 2013

Related U.S. Application Data
(60) Provisional application No. 61/722,131, filed on Nov. 3, 2012.

(51) Int. Cl. F01N 3/20; B01D 53/94

(52) U.S. Cl. CPC F01N 3/208; B01D 53/9495
USPC 423/212; 422/111

(57) ABSTRACT

A method for controlling injection of a reductant into an exhaust system of an internal combustion engine, which includes measuring temperature at a plurality of locations in the exhaust system relative to an SCR catalyst, determining an average temperature as a function of the measured temperatures, and controlling injecting of a reductant into the exhaust upstream of the catalyst as a function of the average temperature. The average temperature may be a weighted average where temperature measurements from at least some locations upstream of the SCR catalyst may be assigned greater weight than temperature measurements proximate the SCR catalyst.

### BACKGROUND

Selective catalytic reduction (SCR) is commonly used to remove NOₓ (i.e., oxides of nitrogen) from the exhaust gas produced by internal engines, such as diesel or other lean burn (gasoline) engines. In such systems, NOₓ is continuously removed from the exhaust gas by injection of a reductant into the exhaust gas prior to entering an SCR catalyst capable of achieving a high conversion of NOₓ.

Ammonia is often used as the reductant in SCR systems. The ammonia is introduced into the exhaust gas by controlled injection either of gaseous ammonia, aqueous ammonia or indirectly as urea dissolved in water. The SCR catalyst, which is positioned in the exhaust gas stream, causes a reaction between NOₓ present in the exhaust gas and a NOₓ reducing agent (e.g., ammonia) to convert the NOₓ into nitrogen and water.

Proper operation of the SCR system involves precise control of the amount (i.e., dosing level) of ammonia (or other reductant) that is injected into the exhaust gas stream. If too little reductant is used, the catalyst will convert an insufficient amount of NOx. If too much reductant is used, a portion of the ammonia will pass unreacted through the catalyst in a condition known as “ammonia slip.” Thus, it is desirable to be able to detect the occurrence of “ammonia slip” conditions in order to regulate dosing levels.

### SUMMARY

Aspects and embodiments of the present technology described herein relate to one or more systems and methods for controlling injection of a reductant into an exhaust system of an internal combustion engine. The exhaust system includes an SCR catalyst that reacts with the reductant to reduce NOx in the engine's exhaust. The method includes measuring temperature at a plurality of locations in the exhaust system relative to the catalyst, determining an average temperature as a function of the measured temperatures, and controlling injecting of a reductant into the exhaust upstream of the catalyst as a function of the average temperature. In some embodiments, the average temperature may be a weighted average. In some embodiments, temperature measurements from at least some locations upstream of the SCR catalyst may be assigned greater weight than temperature measurements proximate the SCR catalyst.

The exhaust system may include a diesel oxidation catalyst (DOC) interposed in the exhaust system between the engine and the SCR catalyst. In such configurations, the method may include measuring a temperature at an inlet of the DOC, measuring a temperature at an inlet of the SCR catalyst and measuring a temperature at an outlet of DOC. The average temperature may be a weighted average in which the temperature measurement at the inlet of the DOC is assigned a greater weighting than the measurements at the inlet and outlet of the SCR catalyst.

In some embodiments, the method may modify reductant injection when the average temperature is outside of a predetermined range. In some embodiments, the method may reduce reductant injection when the average temperature is above a preselected threshold.

In some embodiments, the system may include NOx particulate filter which comprises the SCR catalyst and a diesel particulate filter.

Certain embodiments relate to a method of controlling the injection of a reductant into an exhaust system of an internal combustion engine, where the exhaust system includes an SCR catalyst that reacts with the reductant to reduce NOx in the engine's exhaust and a DOC located upstream of the SCR catalyst. The method measures temperature at a plurality of locations in the exhaust system, including at least an inlet of the DOC, an inlet of the SCR catalyst, and an outlet of the SCR catalyst. The method determines an average temperature as a function of the measured temperatures. In at least some embodiments, the average temperature may be a weighted average in which the temperature measurement from the DOC inlet is given a greater weight than temperature measurements from the inlet and outlet of the SCR catalyst. The method controls injection of reductant into the exhaust system as a function of the average temperature.

Certain embodiments of the present technology relate to a system for controlling the injection of a reductant into an exhaust system of an internal combustion engine. The exhaust system includes an SCR catalyst that reacts with the reductant to reduce NOx in the engine's exhaust and a DOC located upstream of the SCR catalyst. The system includes a first temperature sensor which senses temperature at an inlet of the DOC and producing a first temperature signal responsive thereto. A second temperature sensor senses temperature at an inlet of the SCR catalyst and produces a second temperature signal responsive thereto. A third temperature sensor senses a temperature at an inlet of the SCR catalyst and produces a third temperature signal responsive thereto. A controller receives the temperature signals and controls injection of reductant into the exhaust system as a function of the temperature signals. In at least some embodiments, the controller regulates injection of reductant as a function of an average of the first, second and third temperature signals. In some embodiments, the average temperature is a weighted average, wherein the temperature measurement from the DOC inlet is given a greater weight than temperature measurements from the inlet and outlet of the SCR catalyst. In some embodiments, the controller reduces reductant injection when the average temperature is above a preselected threshold.

### BRIEF DESCRIPTION OF THE DRAWINGS

FIG. 1 is a schematic illustration of an internal combustion engine with an exhaust gas SCR system.

FIG. 2 is flow chart of an exemplary method for detecting ammonia slip in an engine exhaust system according to certain embodiments of the present technology.

### DETAILED DESCRIPTION

Various examples of embodiments of the present technology will be described more fully hereinafter with reference to the accompanying drawings, in which such examples of embodiments are shown. Like reference numbers refer to like elements throughout. Other embodiments of the presently described technology may, however, be in many different forms and are not limited solely to the embodiments set forth herein. Rather, these embodiments are examples representative of the present technology. Rights based on this disclosure have the full scope indicated by the claims.

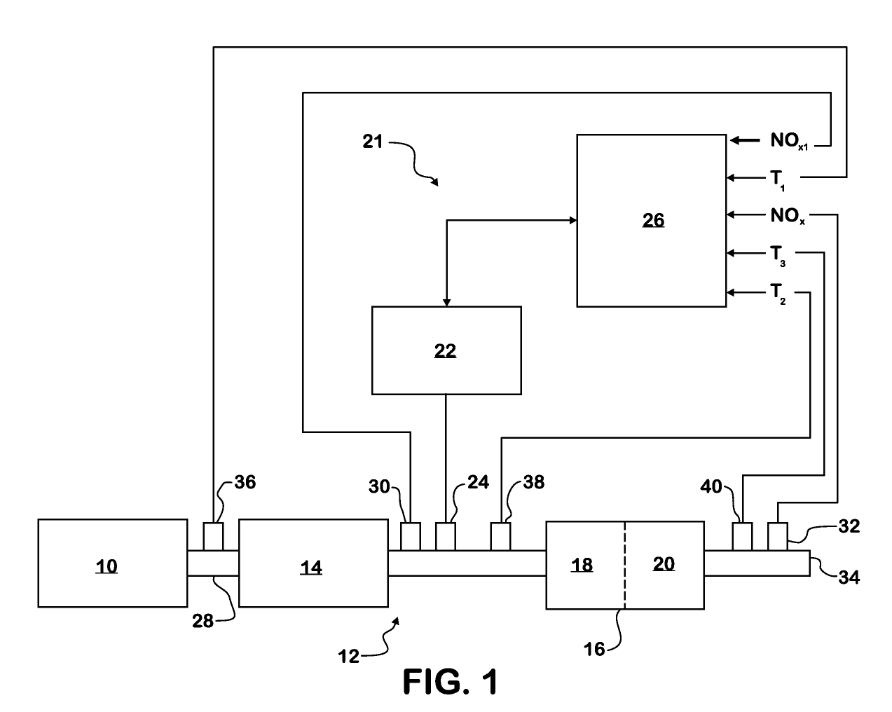

FIG. 1 shows an exemplary schematic depiction of an internal combustion engine 10 and an exhaust aftertreatment system 12. The engine 10 can be used, for example, to power a vehicle such as an over-the-road vehicle (not shown). The engine 10 can be a compression ignition engine, such as a diesel engine, for example. The exhaust aftertreatment system 12 may include a diesel oxidation catalyst (DOC) 14 and a NOₓ particulate filter (“NPF”) 16. The NPF may consist of an SCR catalyst 18 and a diesel particulate filter (“DPF”) 20. The SCR catalyst 18 is part of an SCR system 21 that also includes a reductant supply 22, a reductant injector 24, an electronic control unit (“ECU”) 26 and a plurality of sensors. In the illustrated embodiment, the sensors in the SCR system include an upstream NOₓ detector 30, a downstream NOₓ detector 32 and a plurality of temperature sensors. In the illustrated embodiment, a first temperature sensor 36 is positioned near the inlet of the DOC 36, a second temperature sensor 38 is positioned near the inlet of the NPF 16, and a third temperature sensor 40 is positioned near the outlet of the NPF 16.

The ECU 26 controls delivery of a reductant, such as ammonia, from the reductant supply 22 and into an exhaust system 28 through the reductant injector 24. The reductant supply 22 can include canisters (not shown) for storing ammonia in solid form. In most systems, a plurality of canisters will be used to provide greater travel distance between recharging. A heating jacket (not shown) is typically used around the canister to bring the solid ammonia to a sublimation temperature. Once converted to a gas, the ammonia is directed to the reductant injector 24. The reductant injector 24 is positioned in the exhaust system 28 upstream from the catalyst 18. As the ammonia is injected into the exhaust system 28, it mixes with the exhaust gas and this mixture flows through the catalyst 18. The catalyst 18 causes a reaction between NOₓ present in the exhaust gas and a NOₓ reducing agent (e.g., ammonia) to reduce/convert the NOₓ into nitrogen and water, which then passes out of the tailpipe 34 and into the environment. While the SCR system 21 has been described in the context of solid ammonia, it will be appreciated that the SCR system could alternatively use a reductant such as pure anhydrous ammonia, aqueous ammonia or urea, for example.

The upstream NOₓ sensor 30 is positioned to detect the level of NOₓ in the exhaust stream at a location upstream of the catalyst 18 and produce a responsive upstream NOₓ signal. As shown in FIG. 1, the upstream NOₓ sensor 30 may be positioned in the exhaust system 28 between the engine 10 and the injector 24. The downstream NOₓ sensor 32 may be positioned to detect the level of NOₓ in the exhaust stream at a location downstream of the catalyst 18 and produce a responsive downstream NOₓ signal.

The ECU 26 is connected to receive the upstream and downstream NOₓ signals from the sensors 30 and 32, as well as the signals from the temperature sensors 36, 38, 40. The ECU 26 may be configured to control reductant dosing from the injector 24 in response to signals from the temperature sensors 36, 38, 40 and the NOₓ sensors 30, 32 (as well as other sensed parameters). In this regard, changes in the temperature of the NPF 16 can affect the ammonia storage capacity of the SCR catalyst 18. For example, the catalyst 18 may be configured to operate most efficiently over an exhaust temperature range where the engine operates a majority of time or where the engine produces undesirable amounts of NOₓ. When the temperature in the NPF is outside of this operating range, the efficiency of the SCR catalyst 18 may be adversely impacted. For example, an increase in the temperature of the NPF 16 can reduce the storage capacity of the catalyst 18, which can result in ammonia slip.

In addition to controlling the dosing or metering of ammonia, the ECU 26 can also store information such as the amount of ammonia being delivered, the canister providing the ammonia, the starting volume of deliverable ammonia in the canister, and other such data which may be relevant to determining the amount of deliverable ammonia in each canister. The information may be monitored on a periodic or continuous basis. When the ECU 26 determines that the amount of deliverable ammonia is below a predetermined level, a status indicator (not shown) electronically connected to the controller 26 can be activated.

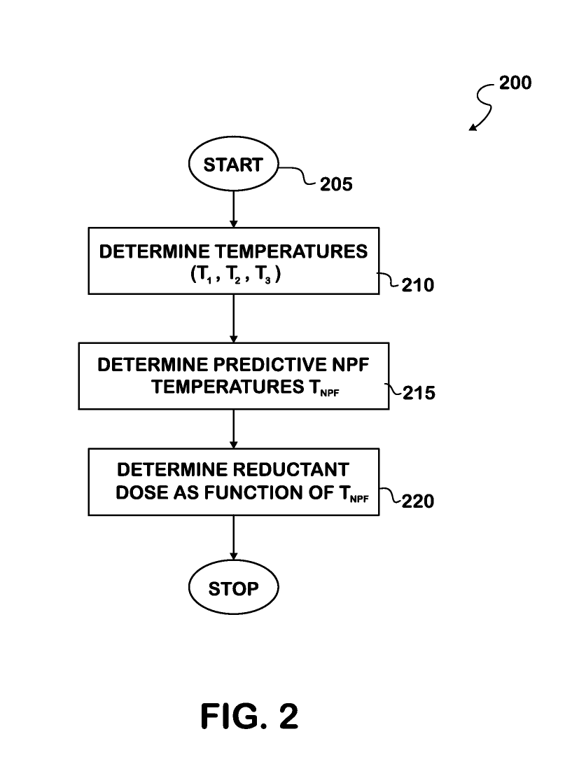

FIG. 2 is a flow chart of an exemplary method 200 according to certain aspects of the present technology. The method 200 begins in step 205. Control is then passed to step 210 where the method determines the temperature at a plurality of preselected locations in the exhaust system. In the illustrated embodiment, the method determines the temperature T1 at the inlet of the DOC by reading the output of the first temperature sensor, the temperature T2 at the inlet of the NPF by reading the output of the second temperature sensor, and the temperature T3 at the outlet of the NPF by reading the output of the third temperature sensor.

Control is then passed to step 215 where the method determines a predictive NPF temperature T_{NPF} based on the temperature readings taken in step 210. In at least some embodiments described herein, the predictive NPF temperature T_{NPF} may be a weighted average of the temperature readings from the temperature sensors 36, 38, 40. In some embodiments, the upstream temperature readings, e.g., at the inlet of the DOC 14, are weighted more heavily than the downstream temperature readings, e.g., at the inlet and outlet of the NPF 16. Using a weighted average, where the upstream temperature readings are given a higher weighting, results in a temperature value that is predictive of temperature changes that will occur in the NPF. For example, in certain embodiments, the predictive NPF temperature T_{NPF} is determined in accordance with the following formula:

T_{NPF}=((T13)+T2+T1)/5

As can be seen, in the above formula, the temperature at the inlet of the DOC is weighted more heavily than the temperatures at the inlet and outlet of the NPF. The above formula is merely exemplary of one strategy that may be used to predict temperature changes in the NPF before they occur. The number and location of the temperature sensors may be varied in accordance with the configuration of the exhaust aftertreatment system, for example. In addition, in some embodiments, the weighting factors may be adjusted (e.g., dynamically) based on other operating conditions. For example, in some embodiments, the weighting parameters may be adjusted as a function of engine operating condition. In some embodiments, a higher weighting factor may be used for the upstream temperature sensors when the engine is undergoing a transient operation versus the weighting factors that are used during steady state operation. Further, in some embodiments, it may be desirable to employ a strategy that uses simulated map-based temperature sensors.

After the predictive NPF temperature T_{NPF} is determined in step 215, control is passed to step 220 where the method determines an ammonia dose based on the predictive NPF temperature T_{NPF} and other control parameters, such as the upstream and/or downstream NOₓ values. For example, where the predictive NPF temperature T_{NPF} increases above a temperature threshold at which ammonia slippage will occur, the method can reduce the ammonia dose to reduce/limit ammonia slippage. Using a weighted average as discussed above will cause the predictive NPF temperature T_{NPF} reading to increase before the temperature of the NPF actually reaches the temperature threshold. According, any corrective action, such as adjusting the ammonia dose, can be taken in advance.

At least some embodiments of the present technology relate to an SCR system 21 for controlling operation of an exhaust aftertreatment system 12 and for reducing ammonia slip. Referring again to FIG. 1, the system 21 may generally include the injector 24, the reductant supply 22, the upstream NOₓ sensor 30, the downstream NOₓ sensor 32, the ECU 26 and the temperature sensors 36, 38, 40. The ECU 26 may be configured to receive signals from the temperature sensors 36, 38, 40 and the NOₓ sensors, and to responsively control operation of the injector 24. In at least some embodiments, the ECU 26 develops a predictive NPF temperature T_{NPF} based on the readings from the temperature sensors 36, 38, 40. The predictive NPF temperature T_{NPF} may be a weighted average, where at least some of the temperature signals are weighted differently and have different weighting factors. In some embodiments, the temperature signals from sensors positioned upstream of the NPF 16 may be given a greater weighting than sensors that are proximate to the NPF 16. The ECU 26 may use the predictive NPF temperature T_{NPF} to regulate operation of the injector 24 to regulate dosing of reductant into the exhaust system. For example, when the predictive NPF temperature T_{NPF} falls outside of a preselected range, the ECU 26 may reduce the reductant dose to reduce ammonia slip.

1. A method of controlling the injection of a reductant into an exhaust system of an internal combustion engine, the exhaust system including an SCR catalyst that reacts with the reductant to reduce NOₓ in the engine's exhaust, the method comprising;
measuring temperature at a plurality of locations in the exhaust system relative to the catalyst;
determining an average temperature as a function of the measured temperatures; and
controlling injecting of a reductant into the exhaust upstream of the catalyst as a function of average temperature.

2. The method of claim 1, wherein the average temperature is a weighted average.

3. The method of claim 1, wherein temperature measurements from at least some locations upstream of the SCR catalyst are assigned greater weight than temperature measurements proximate the SCR catalyst.

4. The method of claim 1, wherein the exhaust system includes a diesel oxidation catalyst (DOC) interposed in the exhaust system between the engine and the SCR catalyst, and wherein the method includes measuring a temperature at an inlet of the DOC, measuring a temperature at an inlet of the SCR catalyst and measuring a temperature at an outlet of DOC.

5. The method of claim 4, wherein the average temperature is a weighted average in which the temperature measurement at the inlet of the DOC is assigned a greater weighting than the measurements at the inlet and outlet of the SCR catalyst.

6. The method of claim 1, further comprising modifying reductant injection when the average temperature is outside of a predetermined range.

7. The method of claim 6, further comprising reducing reductant injection when the average temperature is above a preselected threshold.

8. The method of claim 1, wherein the exhaust system comprises a NOₓ particulate filter which comprises the SCR catalyst and a diesel particulate filter.

9. A method of controlling the injection of a reductant into an exhaust system of an internal combustion engine, the exhaust system including an SCR catalyst that reacts with the reductant to reduce NOₓ in the engine's exhaust and a DOC located upstream of the SCR catalyst, the method comprising;
measuring temperature at a plurality of locations in the exhaust system, the locations including at least an inlet of the DOC, an inlet of the SCR catalyst, and an outlet of SCR catalyst
determining an average temperature as a function of the measured temperatures, the average temperature being a weighted average wherein the temperature measurement from the DOC inlet is given a greater weight than temperature measurements from the inlet and outlet of the SCR catalyst; and
controlling injection of the reductant into the exhaust system as a function of the average temperature.

10. The method of claim 6, further comprising reducing reductant injection when the average temperature is above a preselected threshold.

11. A system for controlling the injection of a reductant into an exhaust system of an internal combustion engine, the exhaust system including an SCR catalyst that reacts with the reductant to reduce NOₓ in the engine's exhaust and a DOC located upstream of the SCR catalyst, the system comprising;
a first temperature sensor which senses temperature at an inlet of the DOC and producing a first temperature signal responsive thereto;
a second temperature sensor which senses temperature at an inlet of the SCR catalyst and produces a second temperature signal responsive thereto;
a third temperature sensor which senses temperature at an inlet of the SCR catalyst and produces a third temperature signal responsive thereto; and
a controller configured to receive the first, second and third temperature signals and control injection of reductant into the exhaust system as a function of the temperature signals.

12. A system as set forth in claim 11, wherein the controller is configured to determine an average temperature as a function of the first, second and third temperature signals.

13. A system as set forth in claim 12, wherein the average temperature is a weighted average and wherein the temperature measurement from the DOC inlet is given a greater weight than temperature measurements from the inlet and outlet of the SCR catalyst.

14. A system as set forth in claim 14, wherein the controller reduces reductant injection when the average temperature is above a preselected threshold.
